(19) United States
(12) Patent Application Publication
(10) Pub. No.: US 2012/0112451 A1
(43) Pub. Date: May 10, 2012

(54) Quick release clamp arrangement

(76) Inventor: Nicholas Long, Swansea (GB)

(21) Appl. No.: 13/284,055

(22) Filed: Oct. 28, 2011

(30) Foreign Application Priority Data
Oct. 28, 2010 (GB) GB1018209.5

(51) Int. Cl. F16L 37/00; F16L 23/00

(52) U.S. Cl. 285/18

(57) ABSTRACT

A quick release pipeline clamp comprises at least two clamp segments 2 clamping two pipeline hubs together, a holding arrangement such as stud and nuts arrangements 15, 17 for holding together ends of adjacent clamp segments so that they form a clamping ring and a hydraulically or electrically actuable arrangement such as quick release nuts 15 for causing said holding arrangement to release its hold. The clamp segments have notched edges to make them more flexible and are elastically flexed around the hubs when held in place. Springs 10, 11 further aid separation when the hold is released.

This invention relates to a clamp arrangement for holding two pipeline hubs in interengagement, either directly and/or through the intermediary of a seal ring, said clamp being adapted to rapidly release said hubs in the event of an emergency. An emergency might for example arise if heavy subsea mining equipment, connected by a pipeline to a ship of other topside platform, falls off a subsea cliff. There is a need for a clamp which is remotely actuable to release a pipeline connection rapidly in the event of an emergency.

To meet this objective the present invention proposes a quick release pipeline clamp arrangement comprising at least two clamp segments adapted for clamping two pipeline hubs into interengagement, a holding arrangement for holding together at least one pair of ends of adjacent clamp segments so that the segments as a whole form a substantially complete clamping ring, and a remotely actuable arrangement for causing said holding arrangement to release its hold, the clamp arrangement being such that the or each said at least one pair of ends are resiliently biased apart.

Preferably said clamp segments have inwardly protruding edge portions which fit over flanges on said pipeline hubs.

Preferably each clamping segment is resilient and elastically flexed when said adjacent ends of said clamp segments are held together.

Preferably notches or grooves in inwardly protruding edge portions of the clamp segments make the clamp segments more flexible.

Alternatively or more preferably in addition, between the or each said pair of adjacent ends, at least one resilient arrangement for biasing that pair of ends apart is provided.

Each of said resilient arrangements preferably comprises a pair of springs, each of which could bias a said segment end away from a lug on a mounting plate on which said clamp segments are moveably mounted.

Preferably said remotely actuable arrangement is hydraulically actuable.

Alternatively it may be actuated electrically.

Three or more clamp segments could be provided but preferably there are only two clamp segments. One or more pairs of adjacent segments may be hinged together at one end. At least one pair of ends of adjacent clamp segments are held together by the or a said holding arrangement. The or each holding arrangement could be in the form of at least one remotely actuable quick release hinge, but preferably comprises one or more (preferably two) studs or bolts held in place by remotely actuable quick release nuts.

The invention will now be described solely by way of example and with reference to the accompanying drawings in which:

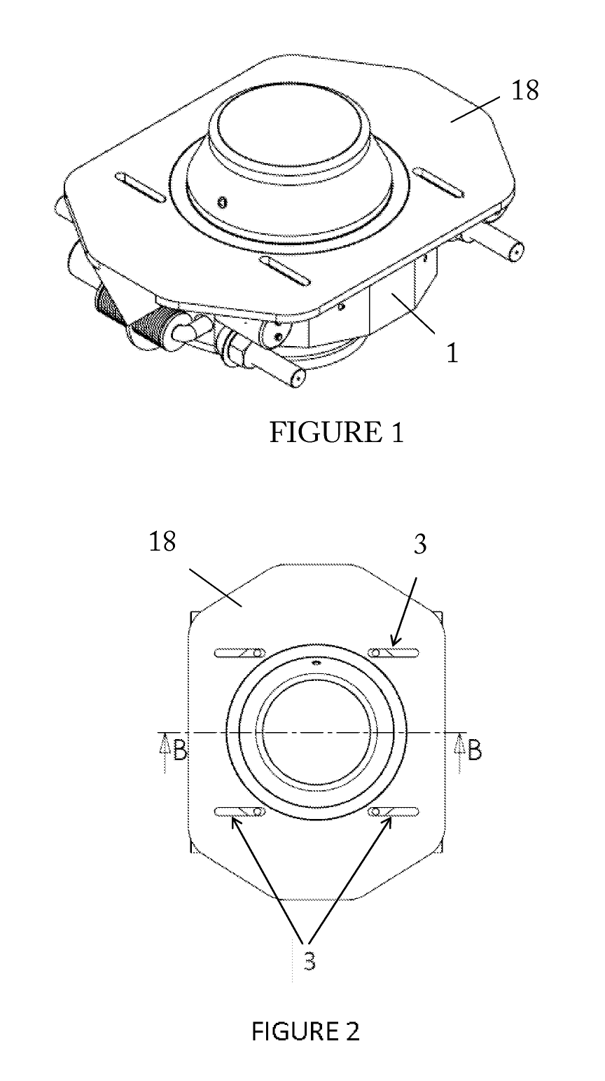

FIG. 1 shows a top perspective view of a clamping arrangement,

FIG. 2 shows a bottom perspective view of the clamping arrangement,

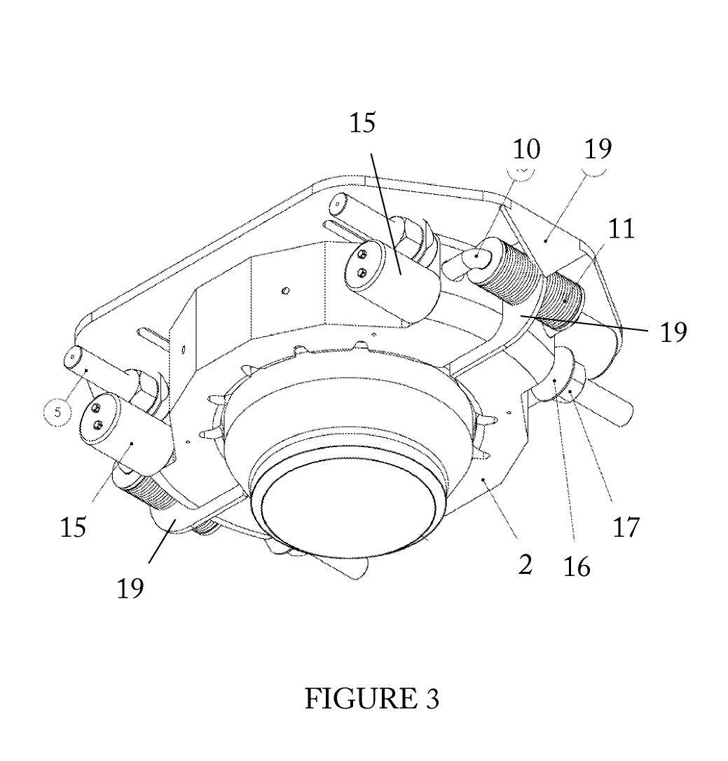

FIG. 3 shows a plan view of the clamping arrangement,

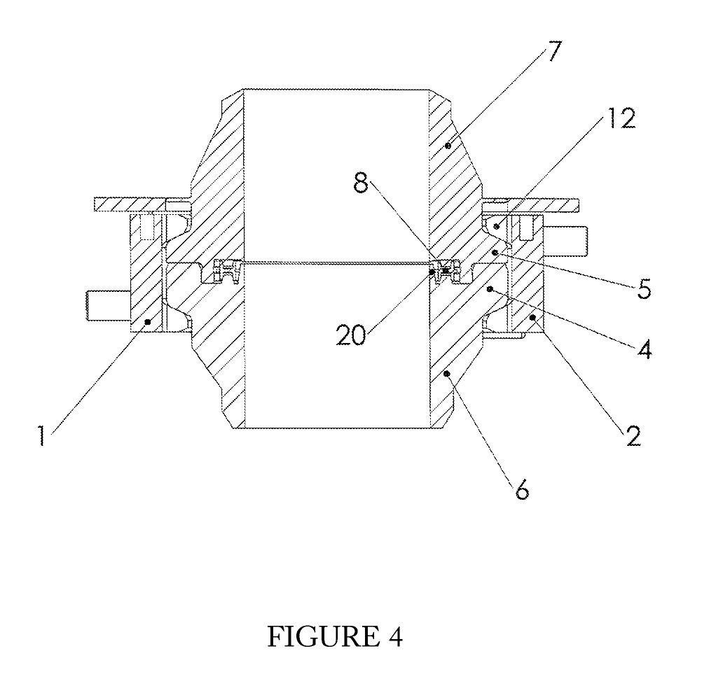

FIG. 4 shows a cross sectional view taken at B-B in FIG. 3,

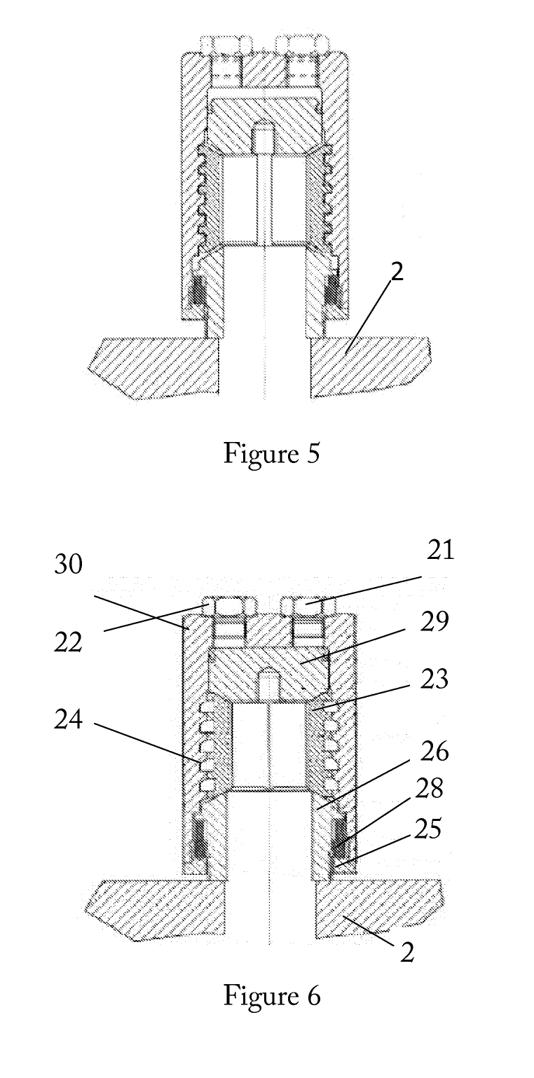

FIG. 5 shows a known quick release nut which has been pressurised and released,

FIG. 6 shows this quick release nut prior to release.

A quick release pipeline clamp arrangement comprising two clamp segments 1, 2 movably mounted by pin and slot connections 3 on a mounting plate 18. As best shown in FIG. 4 clamp segments 1, 2 fit round and have inwardly protruding edge portions 12 which fit over flanges 4, 5 on pipeline hubs 6, 7. The hubs 6 and 7 are thus clamped into interengagement, both directly through their flanges and through the intermediary of a seal ring 8. The seal ring may be as described in United Kingdom Patent Application GB0919321.0. Hub 6 is provided with an annular shroud 8 which protrudes through the bore of the seal ring into close proximity with the hub 7 when the clamp is fully closed. The shroud protects the seal ring from abrasion by mining material passing through the pipeline during use.

As best shown in FIG. 2, each clamping segment 1,2 is resilient and elastically flexed when said adjacent ends of said clamp segments are held together to form a substantially complete clamping ring. The clamp has a slightly larger inner profile (diameter) than the hubs so that the clamp segments are elastically flexed around the hub. The clamp segments contact the hub in the middle first and then the contact gradually spreads out around the hub as the bolts are tightened, with the ends of the segments making contact last. This gives the initial spring to release the clamp segments when the clamp is released and a more even clamp loading on the hubs. In this manner adjacent pairs of segment ends are resiliently biased apart. Notches or grooves 9 in the inwardly protruding edge portions 12 of the clamp segments make the clamp segments more flexible. Three or more clamp segments could be employed. Between each pair of adjacent segment ends, at least one resilient arrangement for biasing a said adjacent pair of segment ends apart is also provided. Each spring arrangement could be a single spring, but as shown each spring arrangement comprises a pair of springs 10, 11 each of which biases a said segment end away from a corresponding lug 19 on the mounting plate 18.

Adjacent ends of said clamp segments are held together by stud and nut arrangements 3 to form a substantially complete clamping ring. As best shown in FIG. 2, two stud and nut arrangements are employed to hold together each pair of adjacent ends of said clamp segments, although it is clear that a single stud and nut arrangement may be employed for each pair of adjacent ends of said clamp segments. Each stud and nut arrangement comprises a stud on one threaded end of which a hydraulically actuable quick release nut 15 is tightened by hand to a predetermined position prior to closure of the clamp. On the other end of the stud a conical washer 16 and a conventional nut 17 are fitted, the nut 17 being bolt tensioned or torque tightened to close the clamp. Suitable hydraulically actuated quick release nuts are known and are manufactured by Hydratight Sweeney Limited which is part of the Hydratight® Group. They use ‘MORGRIP™ as a trademark and refer to their product as a ‘Quicknut’.

FIGS. 5 and 6 show such a quick release nut. It includes four collets 23 quadrantly disposed inside a cylindrical housing 30. The collets are externally castellated and internally threaded.

Prior to fitting and when in use prior to release, all components within the quick release nut are disposed as shown in FIG. 6. A retaining disk 25 which is screw fitted in the bottom of the housing has bores in which springs 28 are located. The springs bias the retaining disc and thus the housing downwardly relative to a pressure ring 26 to the position shown. In this position of the housing upper edges of the pressure ring engage lower edges of the collets 23. The collets are thus resiliently held in their upper and inwardly radially disposed positions relative to the housing with the crests of their castellations 24 engaged against the inner wall of the housing 30.

The bias imposed by the springs is sufficiently strong to prevent relative rotation of components within each quick release nut while it is screwed by hand to a predetermined position on one end of a said stud used to hold a pair of adjacent ends of said clamp segments together. It must not be screwed on too far as this may cause premature release. A quick release nut is not suitable for torque tightening. When all the quick release nuts 15 are on their respective studs and the studs are disposed through the clamp ends as shown in FIG. 3, nuts 17 are bolt tensioned or torque tightened to fully close the clamp.

To release all the quick release nuts simultaneously hydraulic pressure is applied to one or both of two ports 21 and 22 (see FIG. 6) of each quick release nut. Within each quick release nut a piston 29 holds all components within the housing 30 down, while the housing is forced to rise due to the hydraulic pressure therein to a point at which the castellations 14 on the collets move into corresponding recesses in the inner wall of the housing as shown in FIG. 5. Downward pressure on the piston causes, by virtue of tapered surfaces on the lower face of the piston 29 and on the upper face of the pressure ring 16, the collets to move radially outward so that their internal threads are disengaged from mating threads on a stud. The nuts should release in about 5 seconds. The clamp should release from fully closed to fully open position in less than 10 seconds.

1. A quick release pipeline clamp arrangement comprising at least two clamp segments adapted for clamping two pipeline hubs into interengagement, a holding arrangement for holding together at least one pair of ends of adjacent clamp segments so that the segments as a whole form a substantially complete clamping ring, and a remotely actuable arrangement for causing said holding arrangement to release its hold, the clamp arrangement being such that the or each said at least one pair of ends are resiliently biased apart.

2. A quick release pipeline clamp arrangement as claimed in claim 1, said clamp segments having inwardly protruding edge portions which fit over flanges on said pipeline hubs.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

14. (canceled)
